(19) United States
(12) Patent Application Publication
(10) Pub. No.: US 2017/0160786 A1
(43) Pub. Date: Jun. 8, 2017

(54) SMART KEY, CONTROL METHOD OF THE SMART KEY, AND VEHICLE INCLUDING THE SMART KEY

(71) Applicant: Hyundai Motor Company, Seoul (KR)

(72) Inventor: Sang Woo Ji, Yongin (KR)

(21) Appl. No.: 15/058,274

(22) Filed: Mar. 2, 2016

(30) Foreign Application Priority Data
Dec. 7, 2015 (KR) 10-2015-0172989

(51) Int. Cl. G06F 1/32; G07C 9/00

(52) U.S. Cl. CPC G06F 1/3206; G07C 9/00007; G07C 2009/00984; G07C 2009/00769; G07C 2009/00579

(57) ABSTRACT

A smart key includes: a power supply supplying power; a sensor unit sensing a movement of the smart key; and a controller determining whether a movement sensed by the sensor unit corresponds to a predetermined condition and receiving power from the power supply when the sensed movement of the smart key corresponds to the predetermined condition.

### CROSS-REFERENCE TO RELATED APPLICATION

This application claims the benefit of and priority to Korean Patent Application No. 10-2015-0172989, filed on Dec. 7, 2015 in the Korean Intellectual Property Office, the disclosure of which is incorporated herein in its entirety by reference.

### BACKGROUND

1. Technical Field

Embodiments of the present disclosure relate generally to a smart key, a control method of the smart key, and a vehicle including the smart key, and more particularly, to a smart key, a control method of the smart key, and a vehicle including the smart key for supplying power if a movement corresponding to a predetermined condition is sensed.

2. Description of the Related Art

A smart key system enables a driver to open/close doors of a vehicle and start the vehicle from the outside, without having to insert a key into an ignition or a key box or to perform a specific manipulation for starting the vehicle. The smart key system typically uses a smart card having portability or a smart key such as a FOB key for wireless communication.

When a driver possessing such a smart key approaches a vehicle, the vehicle is automatically unlocked through Low Frequency (LF) communication and Radio Frequency (RF) communication with the smart key, so that the driver can open the door of the vehicle without inserting a key and can also start the vehicle without inserting a start key after driving the vehicle. More specifically, operation of the smart key system includes transmitting a searching signal (a LF frequency band) for searching for the smart key around the vehicle, and receiving a searching response signal (an RF frequency band) from the smart key in response to the searching signal.

The vehicle can receive a searching response signal from the smart key only when the smart key is located close to the vehicle, since a transmission distance of a LF signal having a relatively lower frequency band than an RF signal is limited. Accordingly, when the vehicle receives the searching response signal from the smart key, the vehicle can determine that a user has approached the vehicle. Meanwhile, in order for such a smart key to transmit/receive LF signals and RF signals to/from the vehicle in order to control the vehicle, power should be supplied to the smart key.

### SUMMARY

It is an aspect of the present disclosure to provide a smart key for supplying power when a movement corresponding to a predetermined condition is sensed and blocking power when no movement is sensed for a predetermined time period, thereby minimizing power consumption, a control method of the smart key, and a vehicle including the smart key.

Additional aspects of the disclosure will be set forth in part in the description which follows and, in part, will be apparent from the description, or may be learned by practice of the disclosure.

In accordance with embodiments of the present disclosure, a smart key includes: a power supply supplying power; a sensor unit sensing a movement of the smart key; and a controller determining whether a movement sensed by the sensor unit corresponds to a predetermined condition and receiving power from the power supply when the sensed movement of the smart key corresponds to the predetermined condition.

The sensor unit may include at least one of a vibration sensor, an acceleration sensor, and a gyro sensor.

The sensor unit may sense at least one of vibration, shaking, and a change in position of the smart key when sensing the movement of the smart key.

The predetermined condition may include at least one of a number of times by which the movement of the smart key is sensed, a time period for which the movement of the smart key is sensed, and an intensity at which the movement of the smart key is sensed.

When the controller determines that no movement of the smart key is sensed for a predetermined time period, the power supply may block power from being supplied to the controller.

The predetermined time period may be changed automatically or manually.

When the smart key is located inside a vehicle or within a predetermined distance of the vehicle within which the smart key is able to communicate with the vehicle, the controller may receive the power from the power supply.

When the smart key performs at least one operation of Remote Key Entry (RKE) operation, Passive Access Passive Start (PAPS) operation, and developer mode operation, the controller may receive the power from the power supply.

When the power is supplied from the power supply to the controller and a predetermined time period elapses after the smart key performs the at least one operation, the power supply may block power from being supplied to the controller.

The controller may be a FOB Micro Control Unit (MCU).

The smart key may further include a communication unit configured to transmit and receive a control signal to and from a vehicle.

Furthermore, in accordance with embodiments of the present disclosure, a method of controlling a smart key includes: sensing a movement of the smart key;

determining whether a sensed movement of the smart key corresponds to a predetermined condition; and supplying power to a controller of the smart key when the sensed movement of the smart key corresponds to the predetermined condition.

The sensing of the movement of the smart key may include sensing the movement of the smart key using at least one of a vibration sensor, an acceleration sensor, and a gyro sensor.

The sensing of the movement of the smart key may include sensing at least one of vibration, shaking, and a change in position of the smart key.

The predetermined condition may include at least one of a number of times by which the movement of the smart key is sensed, a time period for which the movement of the smart key is sensed, and an intensity at which the movement of the smart key is sensed.

The method may further include blocking power from being supplied to the controller when no movement of the smart key is sensed for a predetermined time period.

The supplying of power to the controller of the smart key when the movement of the smart key corresponds to the predetermined condition may include supplying the power to the controller of the smart key when the smart key is located inside a vehicle or within a predetermined distance of the vehicle within which the smart key is able to communicate with the vehicle.

The supplying of power to the controller of the smart key when the movement of the smart key corresponds to the predetermined condition may include supplying the power to the controller of the smart key when the smart key performs at least one operation of Remote Key Entry (RKE) operation, Passive Access Passive Start (PAPS) operation, and developer mode operation.

The method may further include blocking power from being supplied to the controller when the power is supplied to the controller and a predetermined time period elapses after the smart key performs the at least one operation.

Furthermore, in accordance with embodiments of the present disclosure, a vehicle includes: a vehicle communication unit receiving a control signal from a smart key; and a vehicle controller controlling operation of the vehicle according to information received through the vehicle communication unit. The smart key includes a power supply configured to supply power, a sensor unit configured to sense a movement of the smart key, and a controller configured to determine whether a movement sensed by the sensor unit corresponds to a predetermined condition and receive power from the power supply when the sensed movement of the smart key corresponds to the predetermined condition.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view for describing a relationship between a smart key and a vehicle;

FIG. 2 shows an outer appearance of a vehicle;

FIG. 3 shows an interior of a vehicle;

FIG. 4 shows an outer appearance of a smart key;

FIG. 5 is a block diagram showing configurations of a smart key and a vehicle according to embodiments of the present disclosure;

FIG. 6 is a flowchart illustrating a method of supplying power to a smart key or blocking power from being supplied to the smart key, according to embodiments of the present disclosure;

FIG. 7 is a flowchart illustrating a method of supplying power to a smart key or blocking power from being supplied to the smart key, according to embodiments of the present disclosure;

FIG. 8 is a view for describing an example of a power supply state when a smart key exists inside a vehicle;

FIG. 9 is a view for describing an example of a power supply state when a smart key exists outside a vehicle; and

FIG. 10 is a flowchart illustrating an embodiment of a method of supplying power to a smart key and blocking power from being supplied to the smart key according to operations of the smart key.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

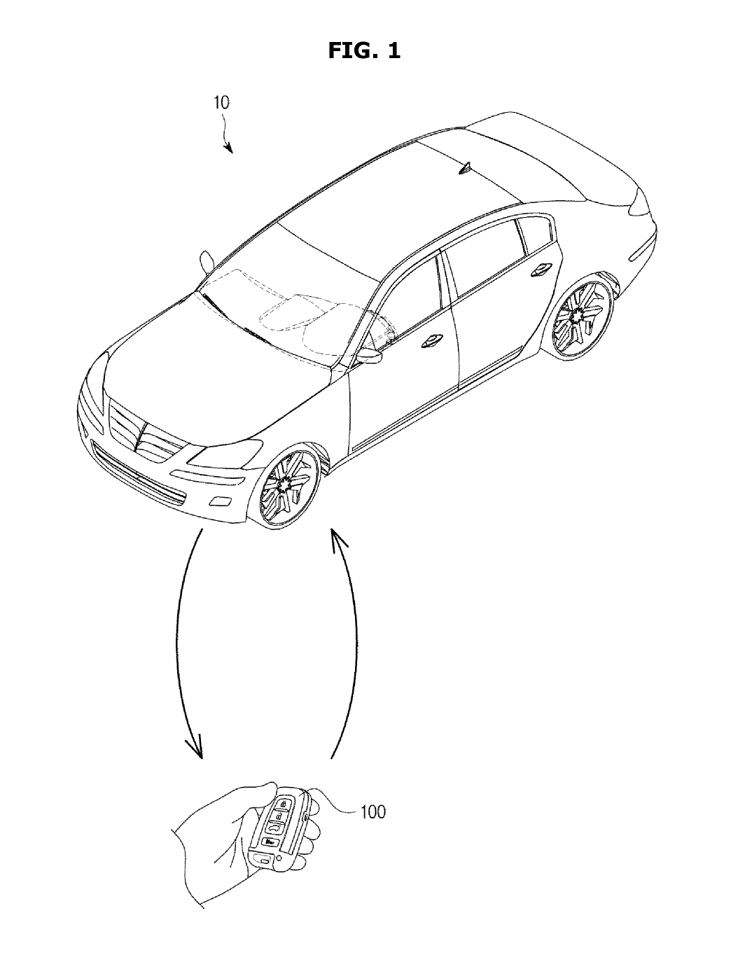

Hereinafter, embodiments of a smart key, a control method of the smart key, and a vehicle including the smart key will be described with reference to FIGS. 1 to 10.

FIG. 1 is a view for describing a relationship between a smart key and a vehicle.

As shown in FIG. 1, a smart key 100 may be an apparatus configured to control a vehicle 10 inside or outside the vehicle 10. Also, the smart key 100 may control the vehicle 10 in such a manner to receive signals transmitted from a plurality of antennas installed in the vehicle 10 and transmit response signals in response to the received signals. Also, a user may control the vehicle 10 using a lock button, a unlock button, or a trunk button of the smart key 100, outside the vehicle 10. If the smart key 100 is located inside the vehicle 10, a user may click a start button to turn on/off the ignition of the vehicle 10.

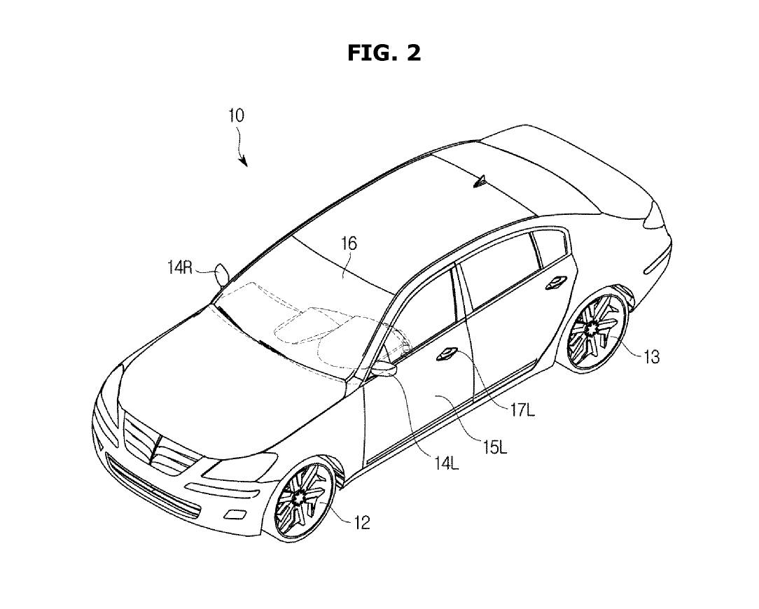

FIG. 2 shows an outer appearance of the vehicle 10.

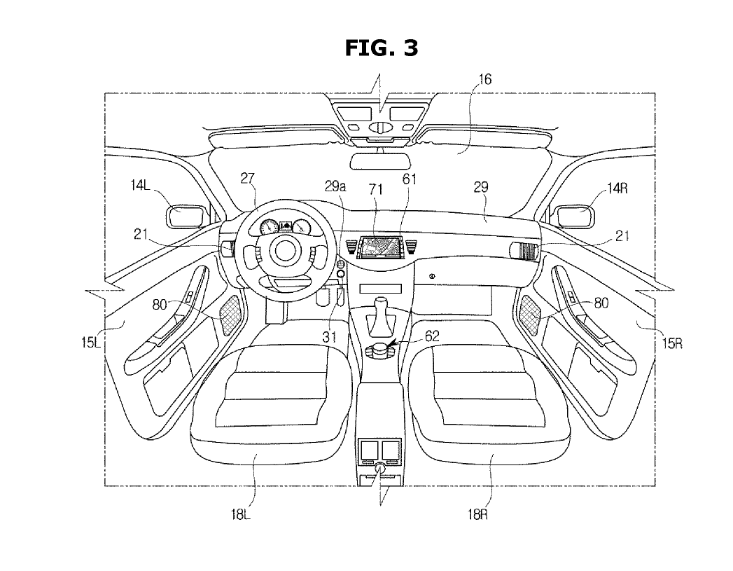

As shown in FIG. 2, the vehicle 10 according to embodiments of the present disclosure may include a plurality of wheels 12 and 13 to move the vehicle 10, a plurality of doors 15L and 15R (see FIG. 3) to shield the interior of the vehicle 10 from the outside, a front glass 16 to provide a driver inside the vehicle 10 with a front view of the vehicle 10, and a plurality of side-view mirrors 14L and 14R to provide the driver with rear views of the vehicle 10.

The wheels 12 and 13 may include a plurality of front wheels 12 provided in the front part of the vehicle 10, and a plurality of rear wheels 13 provided in the rear part of the vehicle 10. A driving apparatus (not shown) installed inside the vehicle 10 may provide rotatory power to the front wheels 12 or the rear wheels 13 so that the vehicle 10 moves forward or backward. The driving apparatus may adopt an engine to burn fossil fuel to produce rotatory power, or a motor to receive power from a condenser (not shown) to produce rotatory power.

The doors 15L and 15R may be rotatably provided to the left and right of the vehicle 10 to allow a driver or passenger to open one of them and get into the vehicle 10. Also, the doors 15L and 15R may shield the interior of the vehicle 10 from the outside when all of them close. Also, a plurality of handles 17L and 17R (not shown) for enabling a driver or passenger to open or close the doors 15L and 15R may be provided on the outer surface of the vehicle 10, and a plurality of Low Frequency (LF) antennas (not shown) for transmitting and receiving LF signals may be respectively installed in the handles 17L and 17R. That is, the LF antennas for transmitting LF signals may be respectively installed in the handle 17L located close to a driver seat 18L (see FIG. 3) and the handle 17R located close to a passenger seat 18R (see FIG. 3). However, the LF antennas for transmitting LF signals may be installed at any other locations inside the vehicle 10.

If authentication between the smart key 100 and the vehicle 10 is completed through a wireless communication network, the door lock of the vehicle 10 may be unlocked. Thus, when a user pulls the handle 17L, the door 15L may open.

The front glass 16 may be provided in the upper, front part of the vehicle 10 to allow the driver inside the vehicle 10 to acquire a front view of the vehicle 10. The front glass 16 is also called a windshield.

The side-view mirrors 14L and 14R may include a left side-view mirror 14L provided to the left of the vehicle 10 and a right side-view mirror 14R provided to the right of the vehicle 10 to allow the driver inside the vehicle 10 to acquire side and rear views of the vehicle 10.

In addition, the vehicle 10 may include a proximity sensor to sense an obstacle or another vehicle behind or beside the vehicle 10, and a rain sensor to determine whether it is raining and to sense an amount of rainfall.

The proximity sensor may send a sensing signal backward or sideways from the vehicle 10, and receive a reflection signal reflected from an obstacle such as another vehicle. The proximity sensor may sense if an obstacle exists beside or behind the vehicle 10, and detect the location of the obstacle, based on the waveform of the received reflection signal. The proximity sensor may use, for example, a method of sending ultrasonic waves or infrared rays and measuring a distance to an obstacle based on ultrasonic waves or infrared rays reflected from the obstacle.

The interior of the vehicle 10 will now be described with reference to FIG. 3, below.

In the center part of a dash board 29, an Audio Video Navigation (AVN) display 71 and an AVN input unit 61 may be provided. The AVN display 71 may display at least one of an audio screen, a video screen, and a navigation screen, selectively, and also display various control screens related to the control of the vehicle 10 or screens related to additional functions.

The AVN display 71 may be implemented with, for example, a Liquid Crystal Display (LCD), Light Emitting Diode (LED), Plasma Display Panel (PDP), Organic Light Emitting Diode (OLED), Cathode Ray Tube (CRT), and/or the like.

The AVN input unit 61 may be located close to the AVN display 71, and implemented as a hard key type. If the AVN display 71 is implemented as a touch screen, the AVN input unit 142 may be provided in the form of a touch panel in the front part of the AVN display 71.

Also, a center input unit 62 of a jog shuttle type may be positioned between the driver seat 18L and the passenger seat 18R. A user may turn or press the center input unit 62, or push the center input unit 62 to the up/down/left/right side to thereby input a control command.

The vehicle 10 may include a sound output unit 80 configured to output sound, and the sound output unit 80 may be a speaker. The sound output unit 80 may output sound required for performing an audio function, a video function, a navigation function, and additional functions.

For example, two sound output units 80 may be respectively positioned in the left door 15L and the right door 15R, and also, one or more sound output units 80 may be additionally positioned in rear doors, the dashboard 29, etc., as necessary.

In the dashboard 29 near the driver seat 18L, a steering wheel 27 may be disposed, and a key seat 29a into which the smart key 100 can be inserted may be formed adjacent to the steering wheel 27. If the smart key 100 is inserted into the key seat 29a, or if authentication between the smart key 100 and the vehicle 10 is completed through a wireless communication network, the smart key 100 may be connected to the vehicle 10.

Also, in the dashboard 29, a start button 31 for turning on/off the ignition of the vehicle 10 may be disposed. If the smart key 100 is inserted into the key seat 29a, or if authentication between the smart key 100 and the vehicle 10 is completed through a wireless communication network, the vehicle 10 may start according to a user's operation of pressing the start button 31.

Meanwhile, the vehicle 10 may include an air conditioner that can perform both heating and cooling to discharge heated or cooled air through air vents 21 to thus control an internal temperature of the vehicle 10.

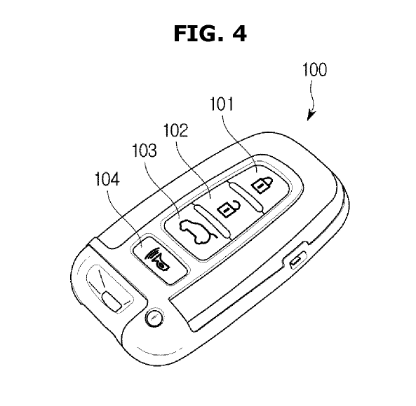

FIG. 4 shows an outer appearance of the smart key 100. As shown in FIG. 4, the smart key 100 may release the door lock of the vehicle 10 when it is inserted into the vehicle 10, or when it receives a control signal from the antennas installed in the vehicle 10 and transmits a response signal in response to the control signal. Also, the smart key 100 may be a FOB key for starting, when it exists inside the vehicle 10, the vehicle 10 so that the vehicle 10 can travel. The smart key 100 may include a hard key 101 for locking the door lock of the vehicle 10, a hard key 102 for unlocking the door lock of the vehicle 10, a hard key 103 for unlocking the trunk 91, and a hard key 104 for causing the vehicle 10 to make warning sound, as shown in FIG. 4. However, the smart key 100 is not limited to the configuration shown in FIG. 4, and may further include a hard key, a button, etc. for performing various functions. Furthermore, the hard keys 101 to 104 may be replaced with a touch type display capable of recognizing a user's touch inputs. Also, the smart key 100 is not limited to a FOB key, and may be any other input device as long as it can control the vehicle 10 in such a way to unlock the door lock or to start the vehicle 10 so that the vehicle 10 can travel. For example, the smart key 100 may be a mobile device (e.g., smart phone, tablet, PDA, laptop, etc.) that can function as a smart key. In this case, an application for enabling the smart key 100 to function as the smart key 100 may be installed in the mobile device. The application may have been installed in the mobile device when the mobile device was released, or may be downloaded in the mobile device after the mobile device is released. In order to use the mobile device as the smart key 100 for the vehicle 10, an authentication procedure may be needed. The smart key 100 may be sold together with the vehicle 10, and store authentication information for connection to the vehicle 10 in advance.

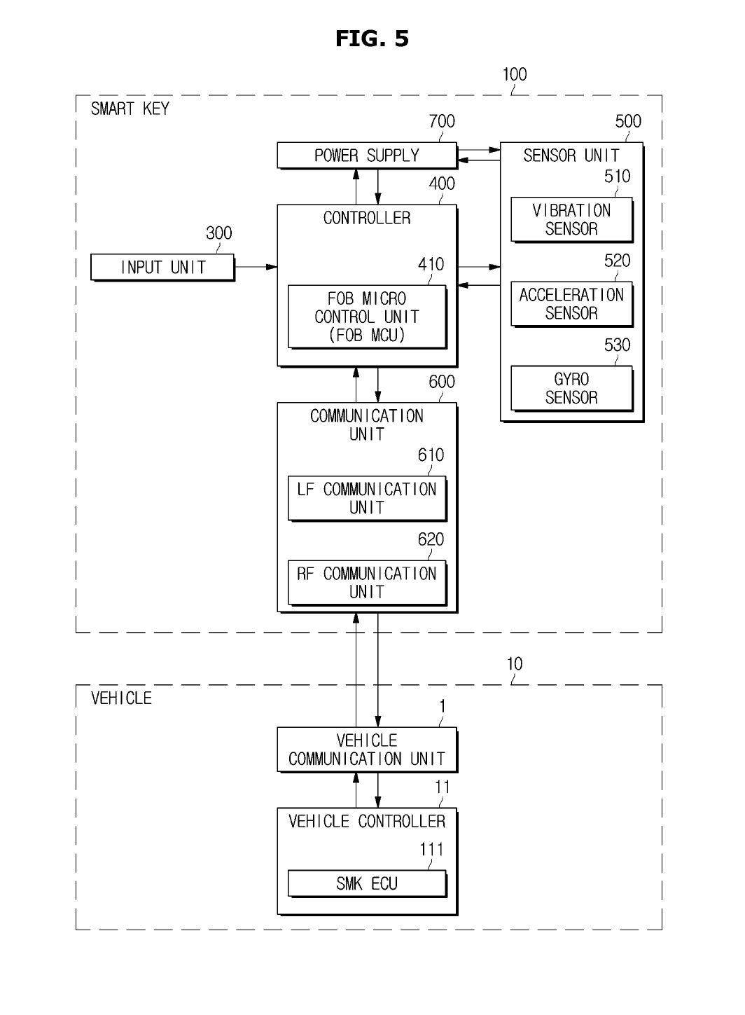

FIG. 5 is a block diagram showing configurations of the smart key 100 and the vehicle 10 according to embodiments of the present disclosure.

As shown in FIG. 5, the smart key 100 may include an input unit 300 configured to enable a user to input a control command for controlling the vehicle 10, a controller 400 configured to control various components in the smart key 100, a sensor unit 500 configured to sense a movement of the smart key 100, a communication unit 600 configured to communicate with the vehicle 100 by transmitting/receiving various signals to/from the vehicle 10, and a power supply 700 configured to supply power to the smart key 100. However, the smart key 100 may further include a display unit (not shown) including a touch recognition function and configured to provide users with various information, and a sound output unit (not shown) configured to output sound. Also, the smart key 100 may further include other components.

The input unit 300 may be configured with a hard key(s), a dial(s), and a display having a touch recognition function, installed on the external surface of the smart key 100, so that a user can input various control commands for controlling the vehicle 10 through the input unit 300. For example, referring to FIG. 4, a user may press one of the hard keys 101 to 104 provided on the external surface of the smart key 100 to lock or unlock all the doors of the vehicle 10, to open or close the trunk, or to make warning sound. A user's control command input through the input unit 300 may be transferred in the form of an electrical signal to the controller 400.

The sensor unit 500 may receive a sensing command from the controller 400 to sense a movement of the smart key 100. Also, the sensor unit 500 may transfer data about the sensed movement in the form of an electrical signal to the controller 400 or the power supply 700.

According to embodiments, the sensor unit 500 may include at least one of a vibration sensor 510 for sensing a degree of vibration, an acceleration sensor 520 for sensing a change in acceleration, and a gyro sensor 530 for sensing a change in position. More specifically, the sensor unit 500 may sense vibration of the smart key 100, shaking of the smart key 100, and/or a change in position of the smart key 100, caused by a movement of a user possessing the smart key 100, to thus sense a movement of the smart key 100. Also, the sensor unit 500 may measure at least one among the number of times by which a movement of the smart key 100 is sensed, a time period for which the movement of the smart key 100 is sensed, and intensity at which the movement of the smart key 100 is sensed, and transfer information about the result of the measurement in the form of an electrical signal to the controller 400.

The controller 400 may include a FOB Micro Control Unit (MCU) which is a processor for controlling components in the smart key 100, and a memory (not shown) to store information. The memory may be at least one type of storage medium among a flash memory type, a hard disk type, a multimedia card micro type, a card type memory (for example, a Secure Digital (SD) memory or an eXtreme Digital (XD) memory), Random Access Memory (RAM), Static Random Access Memory (SRAM), Read-Only Memory (ROM), Electrically Erasable Programmable Read-Only Memory (EEPROM), Programmable Read-Only Memory (PROM), a magnetic memory, a magnetic disk, an optical disk, and the like.

In addition, the controller 400 may process various data and generate control signals to electronically control the smart key 100. Also, the controller 400 may generate a control signal for locking/unlocking the doors of the vehicle 10, a control signal for locking/unlocking the trunk of the vehicle 10, and a control signal for making warning sound, based on electrical signals transferred from the input unit 300. Also, the controller 400 may determine whether information about a movement of the smart key 100 sensed by the sensor unit 500 corresponds to a predetermined condition. A process for the determination will be described below.

First, it is assumed that the predetermined condition is the number of times by which a movement of the smart key 100 is sensed for a predetermined time period. For example, the predetermined condition may be set as a condition of determining that a movement of the smart key 100 is sensed when a movement of the smart key 100 is sensed five times for one second. In this case, if a movement of the smart key 100 is sensed five times or more for one second, the controller 400 may determine that a movement of the smart key 100 is sensed, and if a movement of the smart key 100 is sensed four times or less for one second, the controller 400 may determine that no movement of the smart key 100 is sensed.

Also, it is assumed that the predetermined condition is a time period for which a movement of the smart key 100 is sensed. For example, the predetermined condition may be set as a condition of determining that a movement of the smart key 100 is sensed when the movement of the smart key 100 is sensed for five seconds or more. In this case, if a movement of the smart key 100 is sensed for five seconds or more, the controller 400 may determine that a movement of the smart key 100 is sensed, and if a movement of the smart key 100 is sensed for four seconds or less, the controller 400 may determine that no movement of the smart key 100 is sensed.

Finally, it is assumed that the predetermined condition is intensity at which a movement of the smart key 100 is sensed. For example, the predetermined condition may be set as a condition of determining that a movement of the smart key 100 is sensed when the movement of the smart key 100 is sensed at predetermined intensity or more. In this case, if a movement of the smart key 100 is sensed at the predetermined intensity or more, the controller 400 may determine that a movement of the smart key 100 is sensed, and if a movement of the smart key 100 is sensed at intensity smaller than the predetermined intensity, the controller 400 may determine that no movement of the smart key 100 is sensed. However, the predetermined conditions described above are only exemplary, and the predetermined conditions may be changed by the controller 400.

If the controller 400 determines that a movement of the smart key 100 is sensed, based on any one of the predetermined conditions, the controller 400 may transfer information about the movement of the smart key 100 in the form of an electrical signal to the power supply 700.

Also, if the controller 400 determines that the smart key 100 performs at least one operation of Remote Key Entry (RKE) operation, Passive Access Passive Start (PAPS) operation, and developer mode operation, the controller 400 may transfer information about the determination in the form of an electrical signal to the power supply 700. The RKE operation is operation of locking or unlocking a vehicle using a remote key at a remote location without inserting a key. Accordingly, the RKE operation includes operation in which a user controls a vehicle using a lock button, a unlock button, a trunk button, etc. at a remote location. Also, the PAPS operation is operation in which a user possessing a smart key approaches a vehicle to unlock the vehicle using a door unlock button around the handle of the vehicle (i.e., passive access), and then gets in the vehicle to start the vehicle (i.e., passive start). The developer mode operation is a mode for changing settings or control information of a smart key.

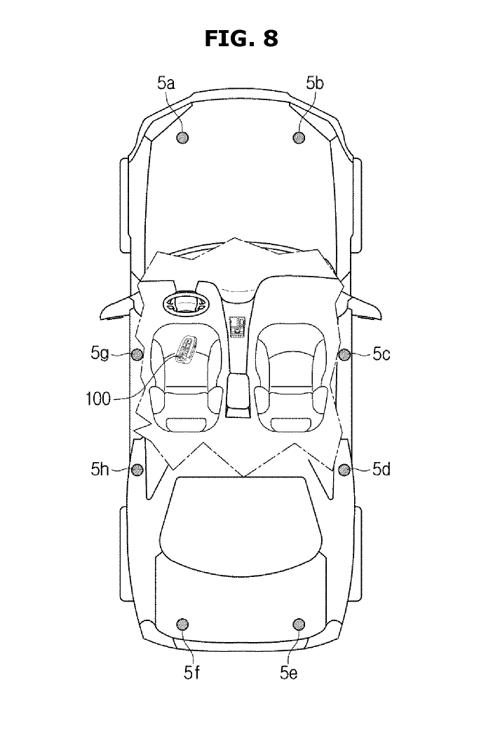

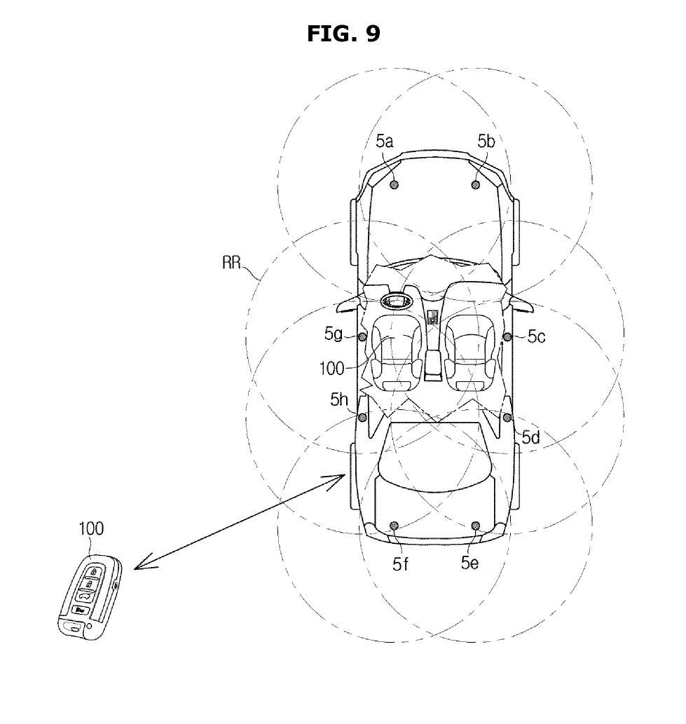

Also, the controller 400 may determine whether the smart key 100 is located inside the vehicle 10 or within a predetermined distance from the vehicle 10 within which the smart key can 100 can communicate with the vehicle 10. This operation will be described in detail with reference to FIGS. 8 and 9, below.

The communication unit 600 may include a Low Frequency (LF) communication unit 610 configured to transmit/receive LF signals to/from a vehicle communication unit 1 of the vehicle 10, and a Radio Frequency (RF) communication unit 620 configured to transmit/receive RF signals to/from the vehicle communication unit 1 of the vehicle 10. The LF signals may be radio signals having a low frequency band from 120 kHz to 135 kHz, and the RF signals may be radio signals having a Ultra-High Frequency (UHF) band from 315 MHz to 433 MHz.

Also, the communication unit 600 may include a memory to store data and programs for modulation/demodulation, and a processor to modulate/demodulate the LF signals or the RF signals according to the data and programs stored in the memory. Accordingly, the communication unit 600 may transmit/receive a LF signal or a RF signal to/from the vehicle 10 in order to perform a procedure of identifying identification (ID) information or transfer a control signal for controlling the vehicle 10.

The LF communication unit 610 may receive a searching signal that the vehicle 10 sends periodically. The searching signal is a LF signal transmitted from the vehicle 10 to a predetermined distance (i.e., a distance allowing LF communication) in order to determine whether the smart key 100 is within the predetermined distance from the vehicle 10 in which the smart key 100 can perform LF communication with the vehicle 10.

The LF communication unit 610 may include a LF communication interface including a communication port to connect the controller 400 of the smart key 100 to a LF communication network and a receiver to receive LF signals. Also, the LF communication unit 610 may further include a LF signal conversion module configured to demodulate LF signals received through the LF communication interface to control signals according to the control of the controller 400 of the smart key 100.

The RF communication unit 620 may transmit a searching response signal to the vehicle 10, in response to the searching signal transmitted from the vehicle 10. The searching response signal is an RF signal transmitted from the smart key 100 to the vehicle 10 in order to inform the vehicle 10 that the smart key 100 has received a searching signal from the vehicle 10.

The RF communication unit 620 may include an RF communication interface including a communication port to connect the controller 400 of the smart key 100 to an RF communication network and a transmitter to transmit RF signals. Also, the RF communication unit 620 may modulate a digital control signal output from the controller 400 of the smart key 100 into an analog communication signal in order to transmit the analog communication signal through the RF communication interface.

As described above, the LF signal is a signal that is received by the smart key 100 through the LF communication network, the RF signal is a signal that the smart key 100 transmits through the RF communication network, and the control signal of the smart key 100 is a signal which is transmitted/received in the smart key 10. The control signal, the RF signal, and the LF signal may have different formats.

The power supply 700 may be used to supply power to components in the smart key 100. Also, the power supply 700 may supply power to the controller 400 or block power from being supplied to the controller 400, according to a movement of the smart key 100 sensed by the sensor unit 500. More specifically, the power supply 700 may receive information about a movement of the smart key 100 sensed by the sensor unit 500, in the form of an electrical signal. If a movement of the smart key 100 corresponding to a predetermined condition is not sensed by the sensor unit 500 for a predetermined time period, the power supply 700 may block power from being supplying to the controller 400 after the predetermined time period elapses. The predetermined time period may be set by a user, and may be changed automatically or manually. For example, if a user sets the predetermined time period to five minutes, the power supply 700 may block power from being supplying to the controller 400 when the movement of the smart key 100 corresponding to the predetermined condition is not sensed for five minutes or more. However, if a movement of the smart key 100 corresponds to the predetermined condition, the power supply 700 may again supply power to the controller 400.

If the smart key 100 performs at least one operation of the RKE operation, the PAPS operation, and the developer mode operation, the power supply 700 may supply power to the controller 400 although no movement of the smart key 100 is sensed.

If a predetermined time period elapses after the smart key 100 performs at least one operation of the RKE operation, the PAPS operation, and the developer mode operation, the power supply 700 may block power from being supplying to the controller 400. The predetermined time period may be set by a user, and may be changed automatically or manually.

If the smart key 100 is located inside the vehicle 10 or within the predetermined distance from the vehicle 10 within which the smart key 100 can communicate with the vehicle 10, the power supply 700 may supply power to the controller 400 although no movement of the smart key 100 is sensed.

The vehicle 10 may include the vehicle communication unit 1 configured to communicate with the smart key 100, and a vehicle controller 11 configured to control electronic components in the vehicle 10.

The vehicle communication unit 1 may include a LF communication unit (not shown) configured to transmit/receive LF signals to/from the smart key 100, and an RF communication unit (not shown) configured to transmit/receive RF signals to/from the smart key 100. The LF signals may be radio signals having a low frequency band from 120 kHz to 135 kHz. Also, the RF signals may be radio signals having a Ultra-High Frequency (UHF) band from 315 MHz to 433 MHz.

The LF communication unit may transmit LF signals to the smart key 100 through the LF communication network. Also, the LF communication unit may transmit a searching signal to the smart key 100 at predetermined time intervals. The searching signal is a LF signal transmitted from the LF communication unit to a predetermined distance (i.e., a distance allowing LF communication) in order to determine whether the smart key 100 exists within the predetermined distance from the vehicle 10 in which the smart key 100 can perform LF communication with the vehicle 10.

The LF communication unit may include a LF communication interface including a communication port to connect the vehicle controller 11 to the LF communication network and a transmitter to transmit LF signals. Also, the LF communication unit may modulate a digital control signal output from the vehicle controller 11 into an analog communication signal in order to transmit the analog communication signal through the LF communication interface.

The RF communication unit may receive an RF signal transmitted from the smart key 100 outside the vehicle 10 through the RF communication network. Also, the RF communication unit may receive a searching response signal from the smart key 100. The searching response signal is an RF signal transmitted from the smart key 100 to the vehicle 10 in order to inform the vehicle 10 that the smart key 100 has received a searching signal from the vehicle 10.

The RF communication unit may include an RF communication interface including a communication port to connect the vehicle controller 11 to the RF communication network and a receiver to receive RF signals. Also, the RF communication unit may further include a RF signal conversion module configured to demodulate an RF signal received through the RF communication interface to a control signal according to the control of the vehicle controller 11.

As described above, the LF signal is a signal that the vehicle 10 transmits through the LF communication network, the RF signal is a signal that is received by the vehicle 10 through the RF communication network, and the control signal of the vehicle 10 is a signal which is transmitted/received in the vehicle 10. The control signal, the RF signal, and the LF signal may have different formats.

If the LF communication unit of the vehicle 10 transmits a searching signal to the smart key 100, and the RF communication unit receives a searching response signal from the smart key 100, the vehicle 10 may perform a series of authentication process with the smart key 100. If authentication is completed, the vehicle controller 11 may unlock various electronic components in the vehicle 10 so that an authenticated user can use the electronic components. For example, if authentication is completed, the vehicle controller 11 may unlock the steering wheel 27, unlock the start button 31, unlock the trunk, and then release the door lock of the handle 17L.

A method for authentication between the vehicle 10 and the smart key 100 is well known in the art, and accordingly, a detailed description thereof will be omitted.

The vehicle controller 11 may include a Smart Key Electrical Control Unit (SMK ECU) configured to control the vehicle 10 through communication between the vehicle 100 and the smart key 100, a steering lock controller configured to control locking/unlocking of the steering wheel 27, a start button controller configured to control locking/unlocking of the start button 32 for turning on/off the ignition of the vehicle 10, and a trunk controller configured to control locking/unlocking of the trunk (not shown) of the vehicle 10. Also, the vehicle controller 11 may further include various control modules configured to control locking/unlocking of the electronic components in the vehicle 10 according to whether authentication with the smart key is successful.

The vehicle controller 11, like the controller 400, may include a memory to store data and programs for controlling the electronic components in the vehicle 10, and a processor for generating control signals according to the data and programs stored in the memory. The vehicle controller 11 may receive a signal transmitted from the smart key 100 through the vehicle communication unit 1, and control the vehicle 10 to perform operation corresponding to the received signal.

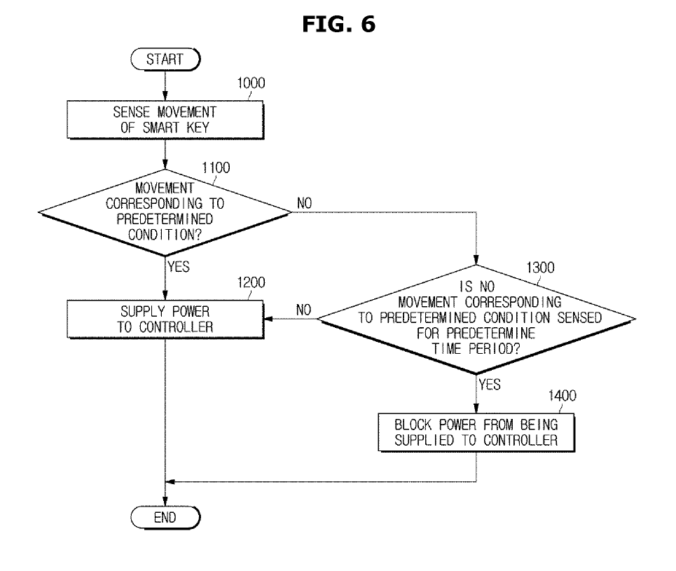

The configurations of the smart key 100 and the vehicle 10 have been described above, and hereinafter, a method of supplying or blocking power according to a movement of the smart key 100 will be described in detail with reference to FIGS. 6 to 10.

FIG. 6 is a flowchart illustrating a method of supplying power to the smart key 100 or blocking power from being supplied to the smart key 100, according to embodiments of the present disclosure.

The sensor unit 500 may use various sensors installed therein to sense a movement of the smart key 100, in operation 1000. For example, the sensor unit 500 may sense vibration or shaking of the smart key 100 when a user possessing the smart key 100 moves. Also, the sensor unit 500 may sense a change in position of the smart key 100 when a user possessing the smart key 100 moves.

The controller 400 may receive information sensed by the sensor unit 500 in the form of an electrical signal, and then determine whether the sensed information represents a movement corresponding to a predetermined condition, in operation 1100.

The predetermined condition may be the number of times by which a movement of the smart key 100 is sensed for a predetermined time period. For example, the predetermined condition may be set as a condition of determining that a movement of the smart key 100 is sensed when a movement of the smart key 100 is sensed five times for one second. In this case, if a movement of the smart key 100 is sensed five times or more for one second, it may be determined that a movement of the smart key 100 is sensed (“Yes” in operation 1100), which can be interpreted as a user's intention to control the vehicle 10 using the smart key 100.

Accordingly, the power supply 700 may supply power to the controller 400, in operation 1200.

However, if a movement of the smart key 100 is sensed four times or less for one second, it may be determined that no movement of the smart key 100 is sensed (“No” in operation 1100). Also, the controller 400 may measure a time period for which a movement of the smart key 100 corresponding to a predetermined condition is not sensed, and determine whether the measured time period exceeds a predetermined time period. That is, the controller 400 may determine whether no movement of the smart key 100 is sensed for the predetermined time period, in operation 1300.

If the controller 400 determines that no movement of the smart key 100 corresponding to the predetermined condition is sensed for the predetermined time period (“Yes” in operation 1300), the power supply 700 may block power from being supplied to the controller 400, in operation 1400. However, if the controller 400 determines that the movement of the smart key 100 corresponding to the predetermined condition is sensed for the predetermined time period (“No” in operation 1300), the power supply 700 may supply power to the controller 400, in operation 1200. That is, if the controller 400 determines that the smart key 100 is in use, power may be supplied to the controller 400, and if the controller 400 determines that the smart key 100 is not in use, no power may be supplied to the controller 400, thereby minimizing power consumption of the smart key 100.

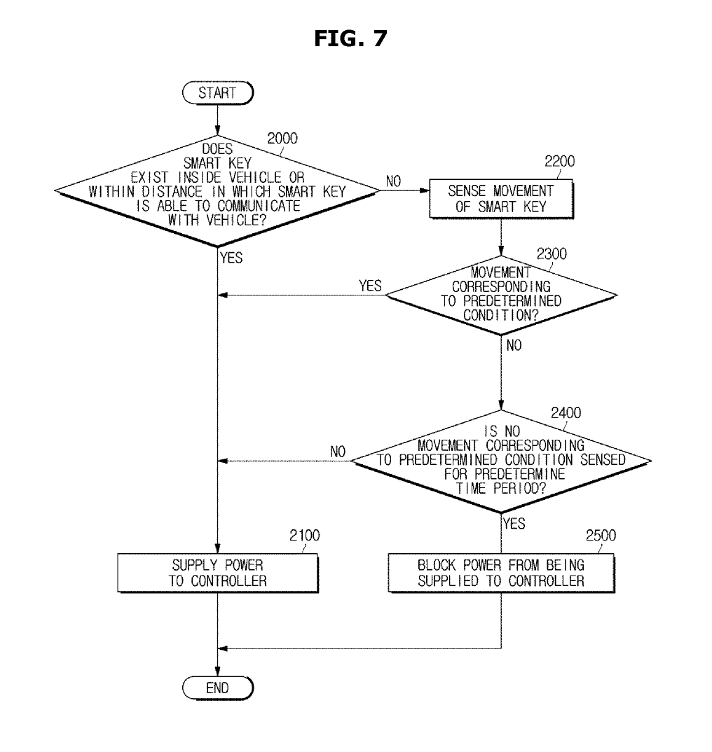

FIG. 7 is a flowchart illustrating a method of supplying power to the smart key 100 or blocking power from being supplied to the smart key 100, according to embodiments of the present disclosure, FIG. 8 is a view for describing an example of a power supply state when the smart key 100 exists inside the vehicle 10, and FIG. 9 is a view for describing an example of a power supply state when the smart key 100 exists outside the vehicle 10.

Hereinafter, a method of supplying power to the smart key 100 or blocking power from being supplied to the smart key 100 when the smart key 100 exists inside the vehicle 10 or within a predetermined distance of the vehicle 10 within which the smart key 100 can communicate with the vehicle 10 will be described with reference to FIGS. 7 to 9.

The controller 400 may determine whether the smart key 100 is located inside the vehicle 10 or within a predetermined distance of the vehicle 10 within which the smart key 100 can communicate with the vehicle 10, in operation 2000. More specifically, the controller 400 may determine whether the smart key 100 exists inside the vehicle 10, based on reception intensity of LF signals transmitted from a plurality of LF antennas 5a to 5g installed in the vehicle 10, as shown in FIG. 8. For example, if LF signals transmitted from all the LF antennas 5a to 5g installed in the vehicle 10 are received with constant intensity through the communication unit 600, the controller 400 may determine that the smart key 100 exists inside the vehicle 10.

Also, the controller 400 may determine whether LF signals transmitted from the LF antennas 5a to 5g installed in the vehicle 10 are received to thereby determine whether the smart key 100 exists within the predetermined distance from the vehicle 10 in which the smart key 100 can communicate with the vehicle 10. As shown in FIG. 9, if the smart key 100 exists outside a range RR to which LF signals output from the LF antennas 5a to 5g installed in the vehicle 10 can be transmitted, the controller 400 cannot receive the LF signals through the communication unit 600. That is, the controller 400 can determine whether the smart key 100 exists within the predetermined distance from the vehicle 10 in which the smart key 100 can communicate with the vehicle 10, based on whether or not LF signals are received.

If the controller 400 determines that the smart key 100 is located inside the vehicle 10 or within the predetermined distance of the vehicle 10 within which the smart key 100 can communicate with the vehicle 10 (“Yes” in operation 2000), the power supply 700 may supply power to the controller 400 although a movement of the smart key 100 corresponding to a predetermined condition is not sensed for a predetermined time period, in operation 2100. If the controller 400 determines that the smart key 100 is not located inside the vehicle 10 or within the predetermined distance of the vehicle 10 within which the smart key 100 can communicate with the vehicle 10 (“No” in operation 2000), the sensor unit 500 may use various sensors in the sensor unit 500 to sense a movement of the smart key 100, in operation 2200. For example, the sensor unit 500 may sense vibration or shaking of the smart key 100 when a user possessing the smart key 100 moves. Also, the sensor unit 500 may sense a change in position of the smart key 100 when a user possessing the smart key 100 moves.

The controller 400 may receive information sensed by the sensor unit 500 in the form of an electrical signal, and then determine whether the sensed information represents a movement corresponding to a predetermined condition, in operation 2300.

The predetermined condition may be the number of times by which a movement of the smart key 100 is sensed during a predetermined time period. For example, the predetermined condition may be set as a condition of determining that a movement of the smart key 100 is sensed when a movement of the smart key 100 is sensed five times for one second. In this case, if a movement of the smart key 100 is sensed five times or more for one second, the controller 400 may determine that a movement of the smart key 100 is sensed (“Yes” in operation 2300), which can be interpreted as a user's intention to control the vehicle 10 using the smart key 100. Accordingly, the power supply 700 may supply power to the controller 400, in operation 2100. However, if a movement of the smart key 100 is sensed four times or less for one second, the controller 400 may determine that no movement of the smart key 100 is sensed (“No” in operation 2300).

In addition, the controller 400 may measure a time period for which no movement of the smart key 100 corresponding to the predetermined condition is sensed, and determine whether the measured time period exceeds a predetermined time period. That is, the controller 400 may determine whether no movement of the smart key 100 is sensed for the predetermine time period, in operation 2400. If the controller 400 determines that no movement of the smart key 100 corresponding to the predetermined condition is sensed for the predetermined time period (“Yes” in operation 2400), the power supply 700 may block power from being supplied to the controller 400, in operation 2500. However, if the controller 400 determines that the movement of the smart key 100 corresponding to the predetermined condition is sensed for the predetermined time period (“No” in operation 2400), the power supply 700 may supply power to the controller 400, in operation 2100. That is, if the controller 400 determines that the smart key 100 is in use, power may be supplied to the controller 400, and if the controller 400 determines that the smart key 100 is not in use, no power may be supplied to the controller 400, thereby minimizing power consumption of the smart key 100.

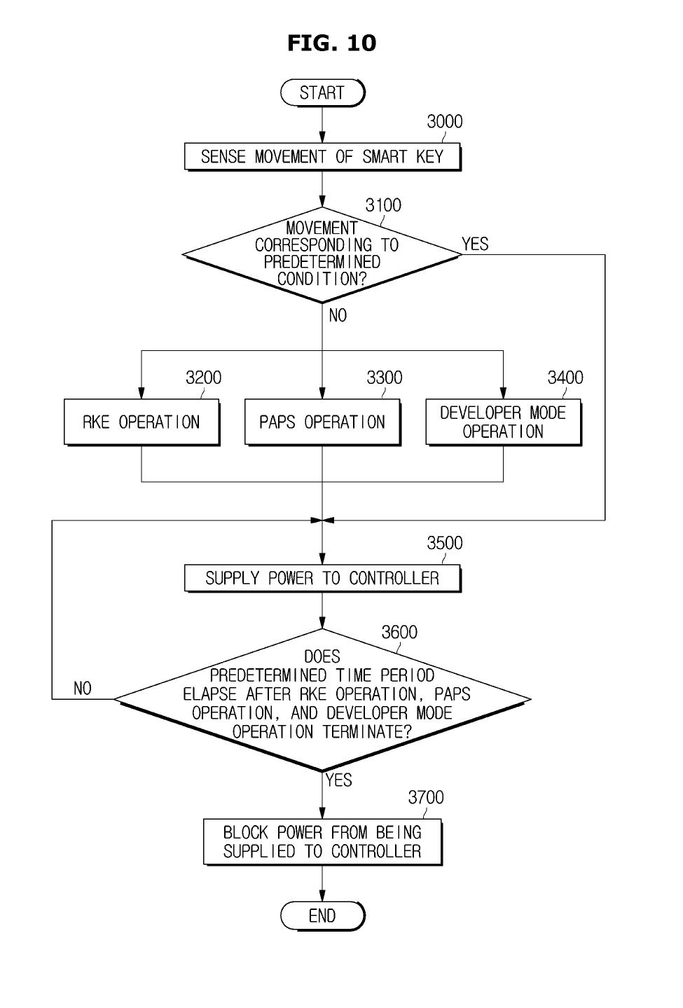

FIG. 10 is a flowchart illustrating embodiments of a method of supplying power to the smart key 100 and blocking power from being supplied to the smart key 100 according to operations of the smart key 100.

The sensor unit 500 may use various sensors in the sensor unit 500 to sense a movement of the smart key 100, in operation 3000. For example, the sensor unit 500 may sense vibration or shaking of the smart key 100 when a user possessing the smart key 100 moves. Also, the sensor unit 500 may sense a change in position of the smart key 100 when a user possessing the smart key 100 moves.

The controller 400 may receive information sensed by the sensor unit 500 in the form of an electrical signal, and then determine whether the sensed information represents a movement corresponding to a predetermined condition, in operation 3100.

The predetermined condition may be the number of times by which a movement of the smart key 100 is sensed for a predetermined time period. For example, the predetermined condition may be set as a condition of determining that a movement of the smart key 100 is sensed when a movement of the smart key 100 is sensed five times for one second. In this case, if a movement of the smart key 100 is sensed five times or more for one second, the controller 400 may determine that a movement of the smart key 100 is sensed (“Yes” in operation 3100), which can be interpreted as a user's intention to control the vehicle 10 using the smart key 100. Accordingly, the power supply 700 may supply power to the controller 400, in operation 3500. However, if a movement of the smart key 100 is sensed four times or less for one second, the controller 400 may determine that no movement of the smart key 100 is sensed (“No” in operation 3100). In this case, if the controller 400 determines that the smart key 100 performs at least one operation of the RKE operation 3200, the PAPS operation 3300, and the developer mode operation 3400, information about the determination may be transferred in the form of an electrical signal to the power supply 700 so that the power supply 700 can supply power to the controller 700, in operation 3500.

On the assumption that power is supplied to the controller 400, after the RKE operation 3200, the PAPS operation 3300, and the developer mode operation 3400 of the smart key 100 terminate, the controller 400 may measure a time period for which no movement of the smart key 100 corresponding to a predetermined condition is sensed, and determine whether the measured time period exceeds a predetermined time period. After the RKE operation 3200, the PAPS operation 3300, and the developer mode operation 3400 of the smart key 100 terminate, the controller 400 may determine whether a state in which no movement of the smart key 100 is sensed is maintained for a predetermined time period, in operation 3600. If no movement of the smart key 100 corresponding to the predetermined condition is sensed for the predetermined time period (“Yes” in operation 3600), the power supply 700 may block power from being supplied to the controller 400, in operation 3700. However, if the movement of the smart key 100 corresponding to the predetermined condition is sensed for the predetermined time period (“No” in operation 3600), the power supply 700 may continue to supply power to the controller 400, in operation 3500. That is, if the controller 400 determines that the smart key 100 is in use, power may be supplied to the controller 400, and if the controller 400 determines that the smart key 100 is not in use, no power may be supplied to the controller 400, thereby minimizing power consumption of the smart key 100.

According to the smart key, the control method of the smart key, and the vehicle including the smart key as described hereinabove, power consumption of the smart key can be minimized to extend the battery life.

Although embodiments have been described by specific examples and drawings, it will be understood to those of ordinary skill in the art that various adjustments and modifications are possible from the above description. For example, although the described techniques are performed in a different order, and/or the described system, architecture, device, or circuit component are coupled or combined in a different form or substituted/replaced with another component or equivalent, suitable results can be achieved. Therefore, other implementations, other embodiments, and things equivalent to claims are within the scope of the claims to be described below.

What is claimed is:

1. A smart key comprising:
a power supply supplying power;
a sensor unit sensing a movement of the smart key; and
a controller determining whether a movement sensed by the sensor unit corresponds to a predetermined condition and receiving power from the power supply when the sensed movement of the smart key corresponds to the predetermined condition.

2. The smart key according to claim 1, wherein the sensor unit includes at least one of a vibration sensor, an acceleration sensor, and a gyro sensor.

3. The smart key according to claim 1, wherein the sensor unit senses at least one of vibration, shaking, and a change in position of the smart key when sensing the movement of the smart key.

4. The smart key according to claim 1, wherein the predetermined condition includes at least one of a number of times by which the movement of the smart key is sensed, a time period for which the movement of the smart key is sensed, and an intensity at which the movement of the smart key is sensed.

5. The smart key according to claim 4, wherein, when the controller determines that no movement of the smart key is sensed for a predetermined time period, the power supply blocks power from being supplied to the controller.

6. The smart key according to claim 5, wherein the predetermined time period is changed automatically or manually.

7. The smart key according to claim 1, wherein, when the smart key is located inside a vehicle or within a predetermined distance of the vehicle within which the smart key is able to communicate with the vehicle, the controller receives the power from the power supply.

8. The smart key according to claim 1, wherein, when the smart key performs at least one operation of Remote Key Entry (RKE) operation, Passive Access Passive Start (PAPS) operation, and developer mode operation, the controller receives the power from the power supply.

9. The smart key according to claim 8, wherein, when the power is supplied from the power supply to the controller and a predetermined time period elapses after the smart key performs the at least one operation, the power supply blocks power from being supplied to the controller.

10. The smart key according to claim 1, wherein the controller is a FOB Micro Control Unit (MCU).

11. The smart key according to claim 1, further comprising a communication unit transmitting and receiving a control signal to and from a vehicle.

12. A method of controlling a smart key, comprising:
sensing a movement of the smart key;
determining whether a sensed movement of the smart key corresponds to a predetermined condition; and
supplying power to a controller of the smart key when the sensed movement of the smart key corresponds to the predetermined condition.

13. The method according to claim 12, wherein the sensing of the movement of the smart key comprises sensing the movement of the smart key using at least one of a vibration sensor, an acceleration sensor, and a gyro sensor.

14. The method according to claim 12, wherein the sensing of the movement of the smart key comprises sensing at least one of vibration, shaking, and a change in position of the smart key.

15. The method according to claim 12, wherein the predetermined condition includes at least one of a number of times by which the movement of the smart key is sensed, a time period for which the movement of the smart key is sensed, and an intensity at which the movement of the smart key is sensed.

16. The method according to claim 15, further comprising blocking power from being supplied to the controller when no movement of the smart key is sensed for a predetermined time period.

17. The method according to claim 12, wherein the supplying of power to the controller of the smart key when the movement of the smart key corresponds to the predetermined condition comprises supplying the power to the controller of the smart key when the smart key is located inside a vehicle or within a predetermined distance of the vehicle within which the smart key is able to communicate with the vehicle.

18. The method according to claim 12, wherein the supplying of power to the controller of the smart key when the movement of the smart key corresponds to the predetermined condition comprises supplying the power to the controller of the smart key when the smart key performs at least one operation of Remote Key Entry (RKE) operation, Passive Access Passive Start (PAPS) operation, and developer mode operation.

19. The method according to claim 18, further comprising blocking power from being supplied to the controller when the power is supplied to the controller and a predetermined time period elapses after the smart key performs the at least one operation.

20. A vehicle comprising:
a vehicle communication unit receiving a control signal from a smart key; and
a vehicle controller controlling operation of the vehicle according to information received through the vehicle communication unit,
wherein the smart key includes a power supply configured to supply power, a sensor unit configured to sense a movement of the smart key, and a controller configured to determine whether a movement sensed by the sensor unit corresponds to a predetermined condition and receive power from the power supply when the sensed movement of the smart key corresponds to the predetermined condition.
